(19) United States
(12) Patent Application Publication
(10) Pub. No.: US 2005/0005529 A1
(43) Pub. Date: Jan. 13, 2005

(54) Lighting system for a greenhouse

(76) Inventors: David Brault, Winnipeg (CA); Wayne Zimmerman, Winnipeg (CA); Paul A. Wasney, Winnipeg (CA); Yvon Normandin, Saint-Lambert (CA); Joesphine Wasney, Winnipeg (CA)

Correspondence Address: ADE & COMPANY, 1700-360 MAIN STREET, WINNIPEG, MB, R3C3Z3, CA

(21) Appl. No.: 10/616,297

(22) Filed: Jul. 10, 2003

(51) Int. Cl. A01G 9/14; E04H 15/18

(52) U.S. Cl. 52/63; 47/17

(57) ABSTRACT

A greenhouse has an exterior curtain wall structure formed by spaced tubular posts carrying external transparent panels and bottom non-transparent wall panels below a sill with the panels spanning the posts. A plurality of benches is located within the interior at spaced positions along one side wall with the width of the benches being equal to the post spacing to form a modular construction. A lighting system is matched with the modular construction of the exterior and includes rails aligned with the posts which carry a row of lighting fixtures arranged for common height adjustment to an optimized predetermined height. The lighting fixture includes a parabolic reflector adjustable to incline the directed light inwardly from the side wall and to change the location of the bulb axis relative to the parabolic axis. The ballasts for the lighting fixtures are housed outside the main greenhouse area in a common cabinet forming a panel in the wall structure.

### THIS INVENTION RELATES TO A LIGHTING SYSTEM FOR A GREENHOUSE

The term greenhouse as used herein is intended to be primarily but not exclusively directed to environmentally controlled growth chambers using primarily natural light and thus having transparent walls, and particularly to such structures having uniform and accurate control of the interior environment. Such structures are primarily intended for use in research or other similar environments where uniform and accurate control is of high importance rather than in crop production facilities where such close control of the environment cannot be economically justified. However the present invention is not intended to be limited to any particular type or use of such a facility.

This application is related to a series of two further applications filed simultaneously with this application and assigned to the same assignee as follows:
Application serial No. INSERT filed INSERT and entitled Structure of a Greenhouse (Docket No. 84215-202);
Application serial No. INSERT filed INSERT and entitled Climate Control for a Greenhouse (Docket No. 84215-402);
The disclosures of the above applications are incorporated herein by reference.

### BACKGROUND OF THE INVENTION

Greenhouses used for research and high value production often include complex and expensive climate control systems for controlling air quality including temperature control by heating and cooling as required, and humidity, by de-humidification and humidification as required. Also such greenhouses are generally designed so as to maximize light availability to the growing plants. Such greenhouses therefore may include shades and lighting systems so as to control the light availability.

Up until now such greenhouses have generally been manufactured in the same manner as commercial buildings in that different contractors and suppliers are contracted to assembly the exterior structure, to provide air handling equipment, to provide electrical control systems, to provide shading systems and to provide lighting systems.

Thus the exterior structure is initially constructed using available constructions systems to provide a primarily transparent exterior structure. However the benches for supporting the plants, the air handling system and the remaining components are not necessarily manufactured so as to best fit within the exterior structure. Thus additional design effort is necessary to design and construct each of the separate components to match the structure of the exterior. One important component is that of the lighting for supplying artificial light.

### SUMMARY OF THE INVENTION

It is one object of the present invention, therefore, to provide a greenhouse having an improved lighting arrangement for providing artificial lighting within the greenhouse.

According to a first aspect of the invention there is provided a greenhouse comprising:
an exterior wall structure having an end wall and two side walls at right angles to the end wall, each of which includes primarily transparent panels allowing entry to an interior of natural light;
a plurality of elongate parallel benches located side by side within the interior at right angles to the end wall and arranged to provide generally horizontal support surfaces for supporting plant materials thereon for receiving the natural light and growing within the interior;
and a lighting system for supplying artificial light to the plant materials on the support surfaces comprising a plurality of rails arranged in parallel spaced positions in a common horizontal plane at a height above the benches with the rails extending parallel to the benches;
each rail supporting a plurality of the lighting fixtures in a row along the rail;
each lighting fixture comprising:
a mounting member for attachment to the respective rail;
a generally parabolic reflector carried on the mounting member so as to be depended facing generally downwardly toward the plant material for directing light toward the plant material;
a lighting bulb support for receiving and supporting a bulb at a position within the parabolic reflector such that light therefrom is reflected by the reflector;
wherein the mounting member of each lighting fixture is pivotal about an axis generally parallel to a parabolic axis of the parabolic reflector relative to the parabolic reflector and to the bulb support so as to adjust the angle of the directed light relative to the rail;
and wherein that row of lighting fixtures adjacent each side wall has the lighting fixtures adjusted such that the lighting direction is angled downwardly and inwardly of the respective side wall.

Preferably the bulb support is movable relative to the parabolic reflector so as to move the bulb within the axial plane of the parabolic reflector so as to move the bulb relative to the parabolic axis to accommodate different types of bulb and/or to change the spread of light at the plant height.

Preferably the parabolic reflector has end walls at right angles to the plane and the bulb support is movable along end walls.

Preferably the parabolic reflector has a generally parabolic shape with a recessed notch in the reflector at the axial plane.

Preferably the recessed notch is V-shaped.

Preferably the parabolic reflector has end walls at right angles to the plane and has inclined ends panels extending from the end walls inwardly and upwardly toward the top of the parabolic shape.

Preferably the end wall has a plurality of posts at spaced positions along the end wall and there are provided beams mounted on the posts and extending parallel to the side walls between the side walls and wherein the rails include a plurality of inner rails aligned with posts and beams and two outer rails each adjacent a respective one of the side walls.

Preferably the rails are interconnected to form an array and are suspended from the beams for common height adjustment of the array.

Preferably the rail height is adjustable to provide an adjustable spacing from top of crop material so that the height can be adjusted to provide a predetermined spacing from the crop as the crop material grows and wherein the reflectors of the array are designed to maximize light intensity at the predetermined spacing.

Preferably the predetermined spacing is of the order of 5 feet.

Preferably each light fixture is associated with a ballast and wherein the ballasts of all the lighting fixtures of the array are associated together in at least one electrical cabinet mounted separately of the lighting fixtures.

Preferably the exterior wall structure is formed from a plurality of posts and wall panels spanning the posts and wherein the at least one cabinet is mounted in wall panel.

According to a second aspect of the invention there is provided a greenhouse comprising:
an exterior wall structure having an end wall and two side walls at right angles to the end wall, each of which includes primarily transparent panels allowing entry to an interior of natural light;
a plurality of elongate parallel benches located side by side within the interior at right angles to the end wall and arranged to provide generally horizontal support surfaces for supporting plant materials thereon for receiving the natural light and growing within the interior;
and a lighting system for supplying artificial light to the plant materials on the support surfaces comprising a plurality of rails arranged in parallel spaced positions in a common horizontal plane at a height above the benches with the rails extending parallel to the benches;
each rail supporting a plurality of the lighting fixtures in a row along the rail;
each lighting fixture comprising:
a mounting member for attachment to the respective rail;
a generally parabolic reflector carried on the mounting member so as to be depended facing generally downwardly toward the plant material for directing light toward the plant material;
a lighting bulb support for receiving and supporting a bulb at a position within the parabolic reflector such that light therefrom is reflected by the reflector;
wherein the bulb support is movable relative to the parabolic reflector so as to move the bulb within the axial plane of the parabolic reflector so as to move the bulb relative to the parabolic axis.

According to a third aspect of the invention there is provided a greenhouse comprising:
an exterior wall structure having an end wall and two side walls at right angles to the end wall, each of which includes primarily transparent panels allowing entry to an interior of natural light;
a plurality of elongate parallel benches located side by side within the interior at right angles to the end wall and arranged to provide generally horizontal support surfaces for supporting plant materials thereon for receiving the natural light and growing within the interior;
and a lighting system for supplying artificial light to the plant materials on the support surfaces comprising a plurality of rails arranged in parallel spaced positions in a common horizontal plane at a height above the benches with the rails extending parallel to the benches;
each rail supporting a plurality of the lighting fixtures in a row along the rail;
each lighting fixture comprising:
a mounting member for attachment to the respective rail;
a generally parabolic reflector carried on the mounting member so as to be depended facing generally downwardly toward the plant material for directing light toward the plant material;
a lighting bulb support for receiving and supporting a bulb at a position within the parabolic reflector such that light therefrom is reflected by the reflector;
wherein the end wall has a plurality of posts at spaced positions along the end wall and there are provided beams mounted on the posts and extending parallel to the side walls between the side walls and wherein the rails include a plurality of inner rails aligned with posts and beams and two outer rails each adjacent a respective one of the side walls;
and wherein the rails are interconnected to form an array and are suspended from the beams for common height adjustment of the array.

According to a fourth aspect of the invention there is provided a greenhouse comprising:
an exterior wall structure having an end wall and two side walls at right angles to the end wall, each of which includes primarily transparent panels allowing entry to an interior of natural light;
a plurality of elongate parallel benches located side by side within the interior at right angles to the end wall and arranged to provide generally horizontal support surfaces for supporting plant materials thereon for receiving the natural light and growing within the interior;
and a lighting system for supplying artificial light to the plant materials on the support surfaces comprising a plurality of rails arranged in parallel spaced positions in a common horizontal plane at a height above the benches with the rails extending parallel to the benches;
each rail supporting a plurality of the lighting fixtures in a row along the rail;
each lighting fixture comprising:
a mounting member for attachment to the respective rail;
a generally parabolic reflector carried on the mounting member so as to be depended facing generally downwardly toward the plant material for directing light toward the plant material;
a lighting bulb support for receiving and supporting a bulb at a position within the parabolic reflector such that light therefrom is reflected by the reflector;
wherein the parabolic reflector has a generally parabolic shape with a recessed notch in the reflector at the axial plane.

According to a fifth aspect of the invention there is provided a greenhouse comprising:
an exterior wall structure having an end wall and two side walls at right angles to the end wall, each of which includes primarily transparent panels allowing entry to an interior of natural light;
a plurality of elongate parallel benches located side by side within the interior at right angles to the end wall and arranged to provide generally horizontal support surfaces for supporting plant materials thereon for receiving the natural light and growing within the interior;
and a lighting system for supplying artificial light to the plant materials on the support surfaces comprising a plurality of rails arranged in parallel spaced positions in a common horizontal plane at a height above the benches with the rails extending parallel to the benches;
each rail supporting a plurality of the lighting fixtures in a row along the rail;
each lighting fixture comprising:
a mounting member for attachment to the respective rail;
a generally parabolic reflector carried on the mounting member so as to be depended facing generally downwardly toward the plant material for directing light toward the plant material;
a lighting bulb support for receiving and supporting a bulb at a position within the parabolic reflector such that light therefrom is reflected by the reflector;
wherein each light fixture is associated with a ballast and wherein the ballasts of all the lighting fixtures of the array are associated together in at least one electrical cabinet mounted separately of the lighting fixtures.

### BRIEF DESCRIPTION OF THE DRAWINGS

One embodiment of the invention will now be described in conjunction with the accompanying drawings in which:

FIG. 1 is a plan view of a green house according to the present invention.

FIG. 2 is a longitudinal cross sectional view through one of the benches of FIG. 1 showing the air handling an conditioning components therein.

FIG. 3 is a transverse cross sectional view of the one of the benches of FIG. 1 showing the bench sliding and tilting features.

FIG. 3A is a transverse cross sectional view of the a plurality of the benches of FIG. 1 showing the position of the benches relative to one another and to the end wall.

FIG. 4 is a cross sectional view through the fan housing and curtain wall at the end of one of the benches of FIG. 1 showing the location of the fan housing relative to the wall, the inlet and outlet openings to the fan housing from the exterior and the location of the channel or chase within the knee wall construction.

FIG. 5 is a transverse cross sectional view through whole structure of FIG. 1 showing arrangement of the posts and trusses and showing the roof venting openings for co-operation with the air handling systems.

FIG. 6 is a cross sectional view through the junction between a post and roof truss showing the steel interconnections within the interior of the tubular frame members.

FIG. 7 is a horizontal cross sectional view through a post and its supported panels showing the curtain wall construction.

FIG. 8 is a plan view on an enlarged scale of the alley showing the plan view of the control cabinets forming the wall panels in the alley.

FIG. 9 is an elevational view of the components shown in FIG. 8 of the alley showing the elevational view of the control cabinets and door panel forming the panels in the alley.

FIG. 10 is a schematic layout of the pressurized water supply system for the fogging nozzles in the air handling duct of FIG. 1 showing the arrangement of pump and accumulator.

FIG. 11 is an exploded isometric view of a lighting fixture of the array of FIG. 1 shown from the top and one end.

FIG. 12 is an isometric view of the lighting fixture of the array of FIG. 1 showing the fixture mounted on the rail.

FIG. 13 is an exploded isometric view of a lighting fixture of the array of FIG. 1 shown from the bottom and one end.

FIG. 14 is a view showing the cross sectional shape of the reflector.

### DETAILED DESCRIPTION

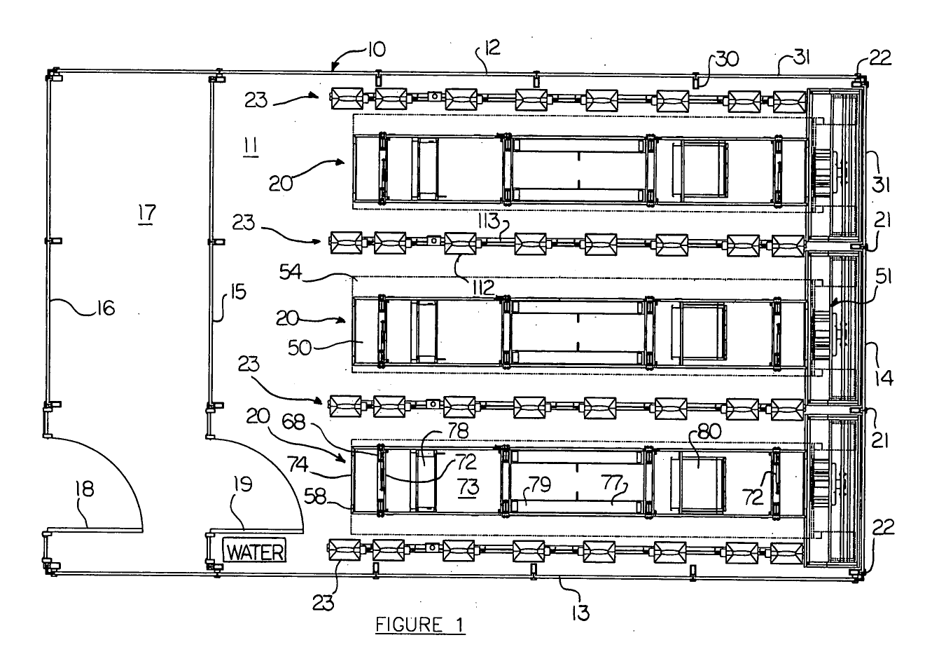

A greenhouse structure is shown in FIG. 1 and comprises an exterior wall 10 supported on a suitable concrete foundation 11 and defining side walls 12 and 13 of the greenhouse together with a first end wall 14 and a second end wall 15. Parallel to the end wall 15 is provided an alley wall 16 so that between the parallel walls 15 and 16 is an alleyway 17. A first door 18 allows access into the alley and is provided in wall 16 and a second door 19 is mounted in the wall 15 so as to allow access from the alley into the main interior of the greenhouse.

Within the greenhouse is mounted a plurality of greenhouse benches generally indicated at 20, each of which comprises an air handling system and a bench top support for plants. The greenhouse is manufactured as an expandable system so that the number of benches to be contained within the greenhouse can be increased or decreased in accordance with requirements by selecting a desired length of the greenhouse to accommodate an according respective number of benches. Thus the outside wall structure is formed in sections which can be added and are associated in width with the benches and associated air handling system so that an addition of further wall sections can be complemented by the same number of additional benches.

Thus the wall 14 is formed from posts 21 and corner posts 22. The distance between each of the post is arranged to be equal to the nominal width of a bench so that each bench fits between a post on the next adjacent post and extends from the wall 14 at right angles to that wall in a direction toward the opposite wall 15. It will be appreciated therefore that the addition of further posts thus increasing the length of the wall 14 and of course the corresponding length of the wall 15 allows the addition of further benches of the same width and same structure as those shown in FIG. 1.

Also shown in FIG. 1 is a lighting system comprising four rows 23 of lamps. Each of the rows 23 is aligned with a respective one of the posts so that two of the rows are directly aligned with the posts 21. Of course the rows at the walls 12 and 13 are necessarily moved slightly inwardly from the wall so as to be approximately aligned with the post 22 but move slightly inwardly to be located within the wall structure which is aligned with the respective corner post described in more detail hereinafter.

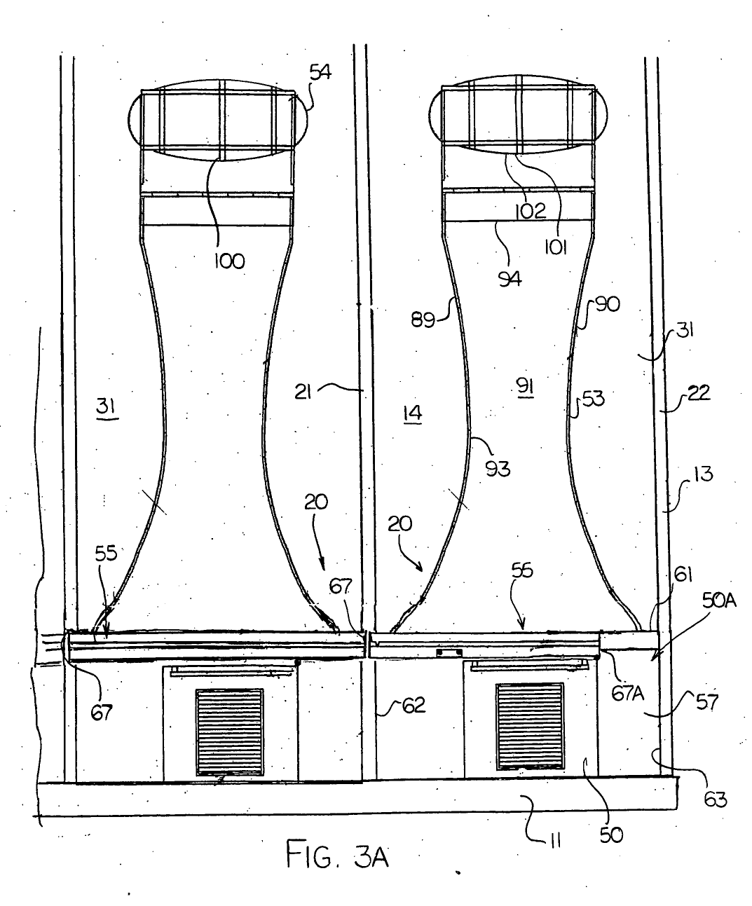

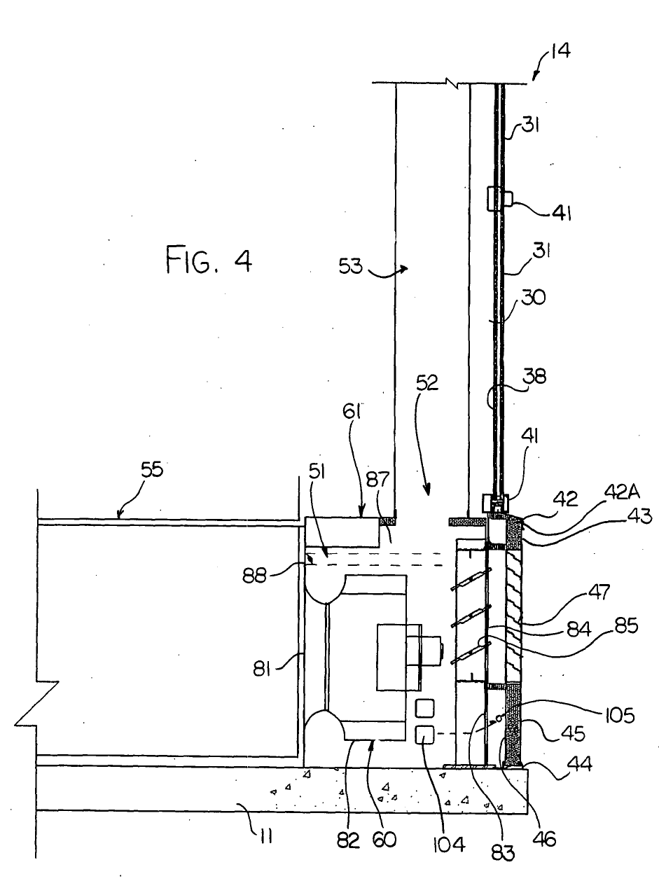

Turning now to FIGS. 4, 5, 6, and 7, the structure of the greenhouse is shown in more detail. Thus from FIG. 5 it will be noted that the greenhouse includes a roof generally indicated at 24 which includes trusses 27 defined by roof rafters 25 converging to an upper apex 26 and horizontal bottom beams 28 interconnected by suitable reinforcing members 27A. The height of the walls is generally of the order of 14 feet thus defining a generally shallow roof structure as is well known in greenhouse construction. The alleyway 17 between the end wall 15 and the alley wall 16 is formed as an extra structure on the otherwise symmetrical greenhouse construction with the roof line defined by the rafters 25A extending downwardly over the alleyway to terminate at the top of the post forming the wall 16.

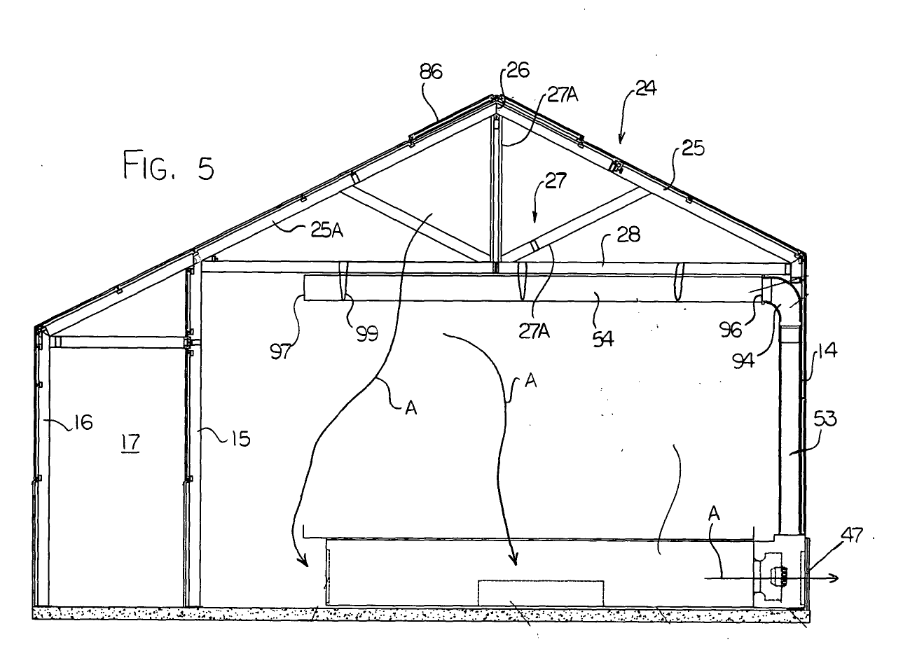

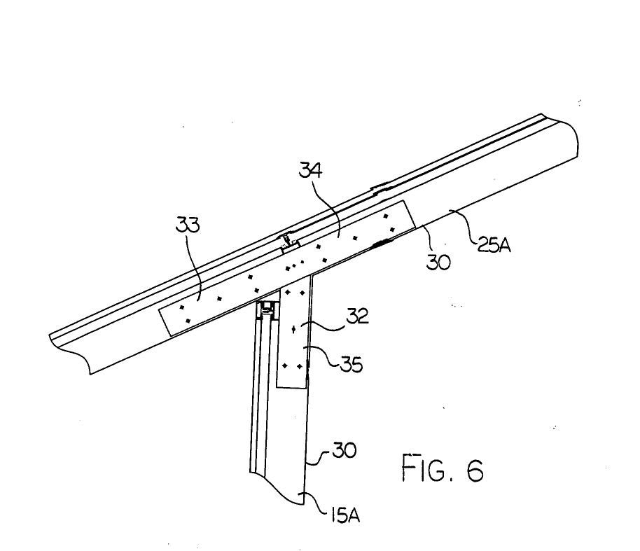

The walls and roof are formed as a curtain wall structure defined by extruded tubular posts 30 (as shown in FIG. 7) and cladding panels 31. The posts 30 are connected one to the next by steel structural members 32 which have legs arranged to insert into the hollow interior of the tubular members 30 so as to provide a connection of each tubular member to the next and reinforcement of the tubular members at the connections. Thus in FIG. 6 is shown a connection at the top of the post 15 defined by the tubular member 30 which is connected to the roof rafter 25A formed by a further tubular member 30 by the inserted steel reinforcement 32 which has legs 33, 34 and 35 which extend into sections of the tubular members 30 at the junction.

At the bottom of each post of the side walls is formed a mounting bracket 36 which attaches the bottom of the post 15A to the concrete floor as shown in plan in FIG. 7.

The cladding panels 31 are attached to the tubular members 30 by a cap 37. Thus the tubular member 30 defines a main tubular portion of rectangular construction having a front wall 38 and side walls 39 and 40. The side walls 39 and 40 extend beyond the front wall 38 into a receptacle section 40 which defines two butting ends 39A and 40A between which is provided a web section 38A extending outwardly from at right angles to the end wall 38. The end of the web section 38A is formed into a channel 38B which faces outwardly from the tubular member and is projecting between the butting ends 39A and 40A. The cap 37 is formed in two parts including an inner part 37A and an outer end 37B. These two parts clip together. The inner part 37A forms a pair of faces facing toward the end faces 39A and 40A so as to define a channel therebetween for receiving two panels 31 and 31A. Thus the panels are held in place against the tubular member by the end cap. This structure therefore forms a curtain wall in that the system comprises the posts which are spaced by the span of the panels and the panels are held against the posts to cooperate with the posts in forming the structural stability. The inner part of the end cap 37 is held in place against the web 38A by a screw fastener which engages into the channel portion 38B thus holding the cap held fixed against a tubular member.

Curtain wall structures of this type are known and other profiles of the tubular members and associated caps can be provided and are available from other manufacturers.

As shown in FIG. 1, the posts along each of the side walls are formed by the tubular members 30 and the panels 31. At the corners, it will be appreciated that it is necessary to provide an additional tubular member attached to the main tubular member which provides a receptacle for two further panels. Again various arrangements are available for providing a curtain wall structure of this type.

As shown in FIG. 4, the panels 31 are separated by horizontal mullions 41 which extend across between the tubular members 30. Thus the panels 31 are rectangular and span between the posts and are formed of a required height so that a specified number of the panels forms a height of the wall up to the roof structure. The panels are thus separated by the transverse mullion which provide a similar channel and cap arrangement by which the panels are attached to the mullion.

The panels 31 are transparent to allow the passage of exterior light into the greenhouse for providing energy to the plants in a conventional manner. A sill 42 is provided at the height of the benches so that below the height of the benches the walls are formed from insulated opaque panels 43. The sill 42 is attached to the tubular member and extends outwardly to an outermost edge 42A which is spaced outside the wall 38 of the tubular member. The sill thus acts to shed water in a conventional manner from the glass panels so that the water is shed away from the base of the post. The insulated panels 43 extend from the sill to a bottom connector 44 which sits on the concrete base 11. The panels 43 in all of the walls except the end wall 14 are simply solid panels with insulation formed as part of the panel thus defining an outer surface 45 at the outer edge 42A of the sill and inner surface 46 which is located underneath the sill and thus spaced outwardly from the tubular member and spaced outwardly from the end wall 38 thereof, with the web 38A removed in this section. This defines therefore an open channel between the inside surface 46 and the tubular members forming the posts thus forming a channel or chase for the passage of electrical leads, control leads and piping for heating and cooling fluids.

In the end wall 14 as shown in FIG. 4, the panel 43 is perforated to form louvers 47 for communication with the fan housing described hereinafter.

Turning now to FIGS. 1, 2, 3 and 3A, the construction of each of the benches including the associated air handling system of the climate control system. Each of the benches 20 comprises a plenum 50 a fan housing 51, an outlet duct 52 from the fan housing which includes a vertical duct portion 53 and a horizontal duct portion 54. On top of the plenum 50 is mounted a bench tray 55 which extends from a first end 56 at the fan housing 51 to a second end 57 projecting beyond an end 58 of the plenum 50. The plenum 50 also has a second end 59 which provides an intake to the fan housing 51 and particularly to a fan 60 mounted within the fan housing.

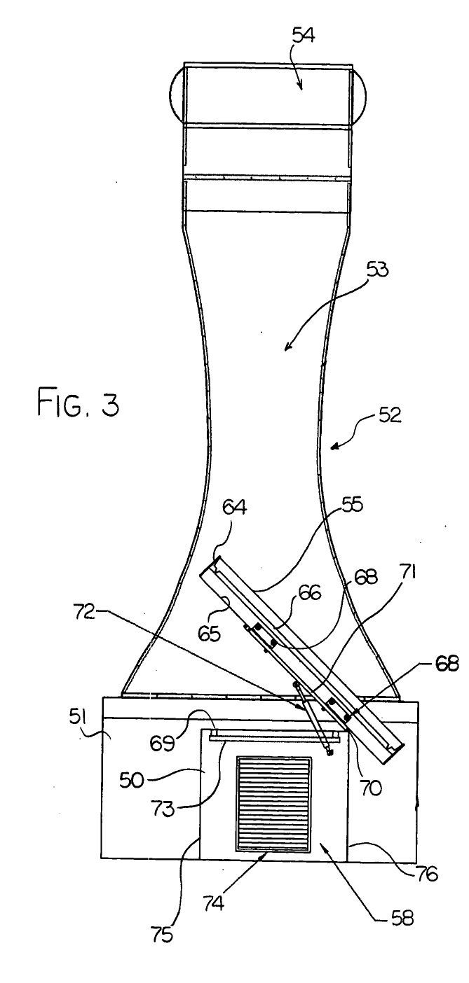

It will be noted from FIGS. 1 and 3A that the fan housing 51 forms a rectangular structure with a base sitting on the concrete floor 11 an upper surface 61 to which the duct portion 53 is attached. The fan housing has sides 62 and 63 which are dimensioned so as to just fit between two of the posts of the end wall 14. Thus an end most one of the benches 20 is located between the corner post 22 and the next adjacent post 21 and a next one of the benches is located between the post 21 and the next adjacent post 21. Thus the width of the benches is equal to substantially the span of the panels 31. The fan housing thus fits between two of the posts and is pushed to a position as far outward between the posts as is possible as best shown in FIG. 1 where the fan housing projects to a position just beneath the height of the sill 42 and located between the posts and extending substantially to the rear or outside surface of the post but leaving the chamber underneath the sill accessible for the communication of piping or wiring as previously described.

The bench trays 55 have an upper surface which is generally at the same height as the top surface 61 of the fan housing and the sill 42 of the framing structure. More particularly, the top surface of the fan housing is underneath the lowers mullion bar at a height of the order of 36 inches. The bench trays are nominally at a height of the order of 32 inches on top of which is received the plants and their containers. This therefore locates the growing plants on the bench tray at the same height as the bottom of the transparent panels 31. Each of the bench trays includes side walls 64 which stand upwardly from a base 65 forming a rectangular container for the plants of a conventional nature. Within the tray is provided a support surface 66 which is formed of a sheet plastics material with ribs and channels for conducting water in a conventional manner well known to one skilled in the art.

Each of the rectangular trays has a length from the end 56 at the fan housing to the end 57 projecting beyond the end wall 58 of the plenum 50. Each of the trays has a width which is nominally equal to the width between the posts 21 so that the side walls 67 of the tray abut the side walls 67 of the next adjacent tray to provide a generally or substantially continuous support surface for the growing plants. The trays of intermediate benches that is benches which are not at the side walls are equal in width to the spacing between the post 21. The end trays have an end wall 67A which is spaced inwardly from the adjacent side wall 12 or 13 to leave an open space into which a user can walk along the open area between the side wall 13 and the side of the plenum 50 as indicated at 50A.

Each of the bench trays is mounted for sliding movement on bearing tracks 68 in a transverse side to side direction relative to the plenum 50. It will be appreciated therefore that the space which is defined for the user to enter into the position alongside the bench can be moved to the other side of the bench by sliding the bench tray horizontally toward the side wall 13. That space can then be moved to the other side of the intermediate bench by sliding the bench tray of the intermediate bench again toward the side wall 14. Thus in an extended greenhouse having many of the benches side by side, all of the benches except one end one or except two end ones of the benches can extend the full width between the posts and the user can get to the side of any one of the benches simply by sliding the benches to the required position to move the space to the required position allowing the user to walk between two of the benches to access the bench on each side of the space. The amount of space necessary is generally of the order of twenty inches thus requiring a sliding movement of each bench of the order of twenty inches and requiring two, generally the endmost ones, of the benches to have a reduced width of ten inches.

The spacing between the posts is equal to the width of the bench and particularly the width of the bench trays as it is selected to be a distance of the order of six feet (or the metric equivalent of two meters) since this provides a bench tray which can be reached from either side with the user being able to reach across the center line of the tray from one side and across the center line of the tray from the other side allowing access to the full area defined by the tray. This width of six feet (two metres) is matched to the spacing between the posts so as to provide a structure in which the greenhouse can be manufactured to accommodate different number of benches simply by adding an additional bay defined by one post and a series of panels and by adding another of the benches which is located between the posts in that bay. The structure further allows the fan housing to be directly associated with the space between the two posts so that it can co-operate with the side wall of the panel below the sill as previously described. Each bench tray is associated with its own air handling system of the climate control system so that air is properly distributed to the plants on the bench so that again the system is expandable in that adding a further bay provides the addition of one further bench and one further air handling system thus avoiding individual design requirements for greenhouse structures as used in conventional practice. The system therefore allows a purchaser to select a greenhouse size and to know that all of the design work is carried out so that the climate control will match the size of the greenhouse and the size of the benches all of which are symmetrical and operate to provide the best climate control which is uniform at the plant height.

The length of the benches, in the embodiment shown, is of the order of eighteen feet so that a construction of four spans of the curtain wall along the side walls provides an alley at the end of the benches which is of the order of four feet. However these lengths are merely examples and can be greater or less as required.

The air handling system of the bench includes the plenum 58, the fan 60 and the duct 52. The plenum 50 comprises a rectangular housing standing on the concrete floor 11 and defining a top surface 69 on which the bench tray 55 sits. The bench tray is mounted for pivotal movement about a hinge 70 at one corner of the housing forming the plenum as best shown in FIG. 3. The bench tray includes a support member 71 which is pivotally connected at the hinge 70 and can fold downwardly to a closed position sitting on the top surface 69. In the position shown in FIG. 3, the support member 71 is pivoted in a clockwise direction by manual lifting of the bench tray 55 while controlled and assisted by an air cylinder 72. Others of the benches may pivot in the same or opposite directions as required. The slide bearings 68 are connected between the tray 55 itself and a support member 71 so that the tray slides back and forth on the bearings relative to the support member, when the support member is in the lowered position. An interlock (not shown) is provided to prevent sliding movement when the support member is unlocked for lifting so as to prevent uncontrolled sliding movement when the tray is moved to the open position shown in FIG. 3.

In the open position access to the open top surface 69 is provided which allows the user to reach into a closing door 73 which acts as a seal for the top of the plenum to prevent air entry into the plenum except at the desired inlet locations described hereinafter. When the bench tray is pivoted to the inclined open position shown in FIG. 3, therefore, the doors 73 can be accessed for opening to allow service work and cleaning within the plenum. The air plenum into which air enters is therefore defined by the door 73 and the sides of the rectangular housing defining the plenum.

The end wall 58 of the plenum includes an inlet 74 which is covered by a grill to allow the entry of air into the plenum at the end wall for movement along the plenum to the fan 60 under suction generated by the fan. The side walls 75 and 76 of the plenum each have an air inlet 77 which is located at the floor 11 and extending along the side of the plenum. The air intake 77 are relatively low forming less than one half of the height of the plenum so as to take air primarily from the floor level.

Inside each of the inlets 74 and 77 is provided a cooling coil 78 and 79 respectively. The cooling coil is thus located across the plenum so that air drawn into the respective inlet passes through the cooling coil. When supplied with cooling fluid, the cooling coil acts to reduce the temperature of the air drawn into the plenum. Downstream of the three inlets 74 and 77 is provided a heating coil 80 which is located between the inlets 77 and the fan 60. When supplied with heating fluid, the heating coil will act to apply heat to the air drawn into the fan. Thus by selecting the requisite level of heating and cooling fluid, the temperature of the air at the fan can be selected in accordance with requirements so that the air supplied to the plants on the bench trays is at the required temperature.

The fan 60 is mounted in the fan housing which is arranged to butt the end wall 59 of the plenum. The fan is of the centrifugal type defining a circular air inlet 81 and an annular air outlet 82 which ejects the air into the rectangular fan housing surrounding the annular outlet 82. As previously described the fan housing 51 communicates with an outlet 47 in the panel 43. The fan housing 51 has a rear wall 83 at the panel 43 which has an opening 84 controlled by flaps 85 which can be moved from a closed position preventing the escape of air from the fan housing through the opening 47 to a controlled open position which allows a controlled amount of air to escape from the fan housing to the exterior through the opening 47. The opening 84 thus acts as an air outlet for expelling air from the interior of the greenhouse pulled into the plenum through the inlets to the plenum. Makeup air into the greenhouse can be drawn through roof vents 86 shown in FIG. 5. These roof vents comprise panels along the roof ridge 26 which are hinged at the roof ridge and can be pivoted upwardly away from the roof line to provide an opening on the underside of the roof vent. The climate control system can therefore be controlled to manage the temperature within the green house by drawing air along the paths marked by the arrows A so that exterior air is drawn into the roof space an expelled through the vent 47.

A duct 87 is also provided through the fan housing from the exterior into the plenum 55. The duct 87 is located at a position spaced from the opening 47 and provides an inlet duct connecting with the exterior through the panel 43 and connected onto the suction side of the fan in the plenum 55. The duct 87 can be controlled by a flap valve 88 so as to allow air from the exterior into the plenum drawn by the reduced pressure of the suction side of the fan. The flap valve 88 is used separately from the flap valves 85 so that in a different mode of operation air is drawn into the greenhouse through the duct 87 to increase the pressure inside the greenhouse thus requiring excess air to be expelled through the roof vent 86.

These different modes of operation of the natural air ventilation system using exterior air can be used in different circumstances depending upon the temperature of the exterior air and the temperature within the greenhouse. The user can operate the system to provide optimum control of temperature for maximum consistency by selecting the mode, selecting the heating, cooling and humidification systems which are optimum in the circumstances as will be well known to one skilled in this art and to provide a required amount of fresh air from the exterior.

The vertical duct section 53 is connected to the top wall 61 of the fan housing so as to receive pressurized air therefrom. The vertical duct 53 is arranged at the end wall 14 between the posts 21, 22 close to the panels. The vertical duct portion is formed from two parallel walls defining a front and rear wall which extend from the top surface 61 upwardly to a position closely adjacent the roof beams 28 as shown in FIG. 5. The vertical duct thus has a rectangular open bottom mouth defined by sidewalls 89 and 90 connecting the front wall 91 to the rear wall 92. The side walls 89 and 90 from their position connected with the top surface 61 of the fan housing converge inwardly to a neck section 93 and then diverge outwardly to an upper elbow 94. The elbow 94 has a horizontal bottom mouth 95 which is rectangular and connects to the top of the vertical duct portion. The elbow 94 forms a vertical mouth 96 at its upper end facing along the green house from the end wall 14 toward the opposite end wall 15 along the beams 28.

The elbow 94 and the vertical duct section 52 are formed from rigid transparent plastics material so as to be self supporting and fixed standing upwardly from the upper surface of the fan housing. These are transparent material allows the passage of light so as to reduce the interference with the natural light through the walls of the greenhouse.

The horizontal duct portion 54 is formed from a tubular body of flexible plastics material which is again transparent or translucent. The tubular body has a closed outer end 97 spaced outwardly from the open mouth 96 of the elbow 94. The opposite open end of the tubular body forming the duct portion 54 is engaged onto the end face 96 of the elbow 94 by horizontal top and bottom clamping bars 98 and semi-circular end pieces. Thus the flexible tubular body forming the duct portion 54 is held substantially elongate at its open mouth. The tubular body is suspended from the roof beams 28 on straps 99 so as to simply to extend along the roof beams 28 directly over the bench. The tubular body is inflated by the air from the vertical duct portion but is prevented from forming a circular cylindrical cross section by a plurality of vertical webs 100 which are arranged along the length of a tubular body at positions spaced across the width of the body and standing in a vertical plane. Thus the body when inflated forms generally an elliptical cross section with a wider bottom surface 101 than the height between the top and bottom surfaces which are defined by the webs 100. The bottom surface has an array of holes 102 which causes the air to escape from the underside of the tubular body and flow from the tubular body down toward the growing plants. The air flow is selected relative to the total areas of holes so that the air escapes from the tubular body under sufficient pressure to generate a velocity at the plants of the order of 50 ft/min which is known in the art to provide suitable gas exchange at the plant surfaces

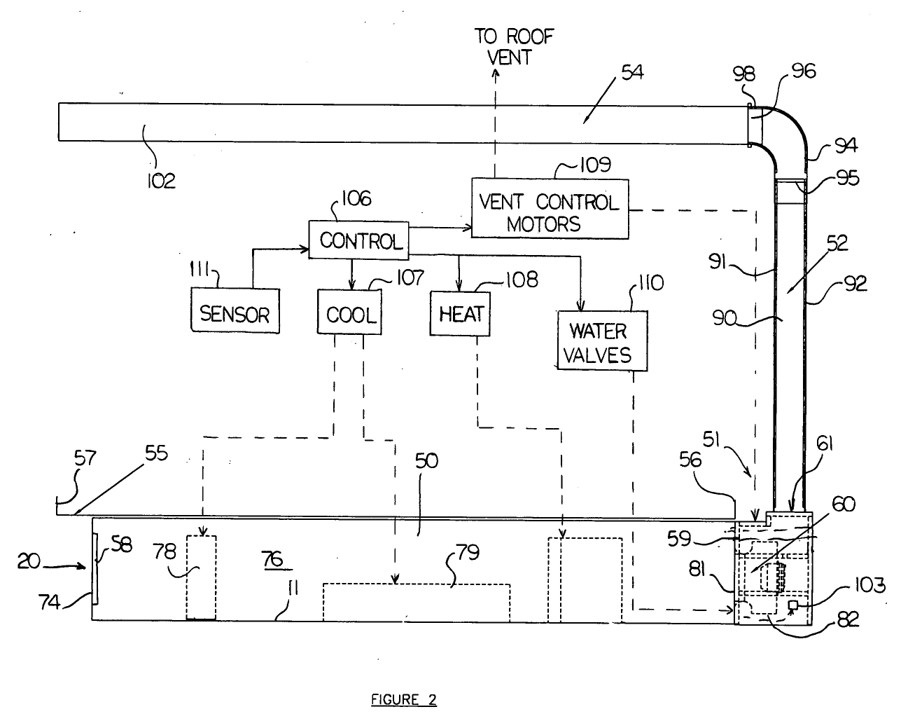

In the fan housing is also provided a water droplet injection nozzle or fogging system schematically indicated at 103 which includes a control valve 104 for controlling the injection of water droplets into the valve housing from a water supply through a chase 105 located in the chamber underneath the sill 42. The control system is shown schematically in FIG. 2 and comprises a controlled unit 106 which is arranged to control the supply of cooling fluid via cool control 107, to control the supply of heating fluid through a heating control 108, to control the position of the vents at the roof and in the fan housing through a vent motor control 109 and to control the supply of water droplets through a valve control 110. The control unit receives inputs from one or more sensors 111 which detect the temperature and humidity of the air at the plants.

The humidity of the air can also be carefully controlled either by dehumidifying the air or by adding water droplets at the nozzles 103. Dehumidifying the air is effected by sub-cooling the cooling coils 78 so that the cooling coil 78 is cooled to a lower temperature than the cooling coils 79. This acts to sub cool the air passing through the cooling coil 78 which extracts moisture from the air which is then suitably collected at the cooling coil and run to drain. Thus the cooling effect of the cooling coil 79 is relatively reduced in order to provide a reduction in temperature and the cooling coil 78 of the air which is lower than the resultant air temperature required thus acting to extract more moisture at the cooling coil 78 than would be obtained if all three cooling coils were run at the same cooling temperature. In extreme conditions of high humidity requiring a reduction in humidity for the interior of the greenhouse, it may be necessary to run the cooling coil 78 and at the same time to run the heating coil to reheat the air to the required temperature prior to pumping by the fan back to the horizontal discharge duct 54.

Humidification of the air is effected simply by the spraying of water droplets in a fogging system from the nozzle 103 within the fan housing. Water is supplied to the nozzles at a pressure of the order of 1000 PSI so as to form small droplets from the fogging system which are carried from the fan housing to the duct while evaporating in the air being transported through the duct for discharge into the greenhouse above the plants.

The use of the individual duct for each bench ensures that each bench is supplied with the same air in the same quantity and pattern since each of the air handling systems is managed symmetrically. The use of relatively flat wide discharge duct above the bench ensures that the air is deposited with little or no pressure downwardly over the full area of the bench so that each location on the bench receives substantially the same air movement from the duct. The duct is slightly narrower than the width of the bench but the location of holes around the hole whole of the underside of the duct 54 allows air to be expelled both directly downwardly and slightly to the sides of the duct.

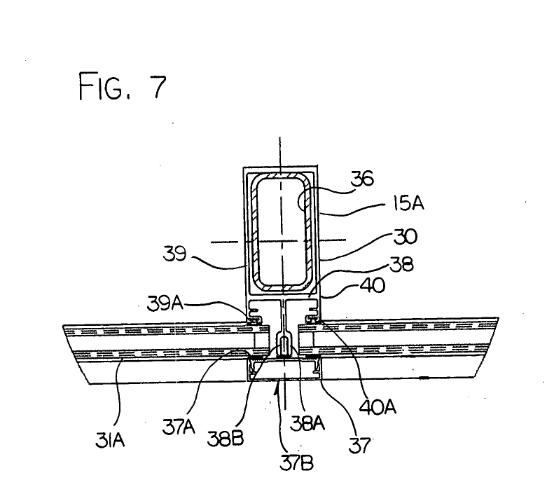

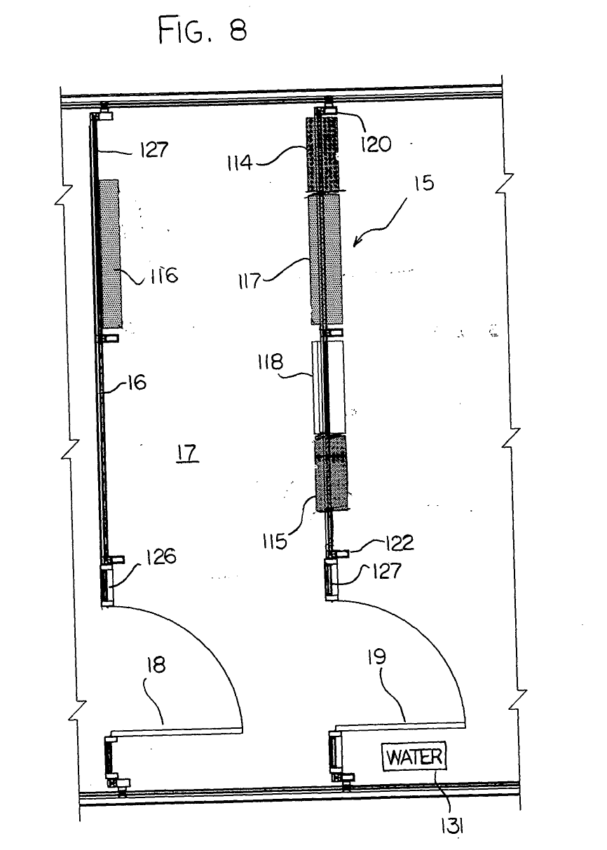

The lighting system including the rows 23 of lighting elements comprises a plurality of individual light fixtures 112 mounted on a rail 113. These lighting fixtures includes a reflector and bulb but the ballast unit for the individual lighting fixtures are collected together in a cabinet 114 and 115. The control unit and the electrical connections and control elements necessary therefore are provided in plurality of cabinets 116, 117 and 118. These cabinets are conveniently located as shown in FIG. 8 in the alley 17.

As previously described the structure of the greenhouse is formed by panels which are inserted between posts where the panels are carried in the channels defined between the tube member and the cap. The cabinets are thus conveniently formed as panels which are arranged to be inserted in the alleyway between posts 120, 121 and 122 respectively. Thus the cabinet 114 and the cabinet 117 together form a panel with seals at the top and sides which allow the panels to co-operate with the channels of the posts 120 and 121 and the mullion piece 124 at the top of the panels. The bottom of the cabinets is raised from the floor and sits on a stand 123 at the bottom with a rear panel of the stand closing the area underneath the cabinet against communication if air between the alley and the greenhouse.

In a similar manner the cabinets 118 and 115 are mounted in a panel 125 which is located between the posts 121 and 122. Again the panels include top and side seals which engage the posts and mullion bar. The ballast cabinets 114 and 115 generate significant heat so they include inlet vents 126 for allowing fan generated air flow cooling.

Thus the pre-formed system of the greenhouse is maintained in that modular panels can be supplied for mounting in the location between the posts in the conventional manner previously described so that it is no longer necessary to manufacture or supply separate electrical cabinets and the location of those cabinets is conveniently provided for in the alley within the panels. Similarly the cabinet 116 is mounted in the panel 127 in the wall 16. Because the cabinet 116 is located in the exterior wall 16, it is mounted wholly within the structure so that the panel runs along the back of the cabinet 116. The cabinets 114. 117, 118 and 115 may be mounted as shown so that they project through the respective panel so as a portion of the cabinet is on each side of the panel. Each of the cabinets has a door or doors which is accessible from the alley 17.

The electrical cabinets contain the electrical components provided in the control system and all other electrical elements including a main power supply and a backup power supply in the event of an initial power failure.

In a similar manner, each of the doors 18 and 19 is formed as a panel 126, 127 so that it can be readily installed as part of the curtain wall system by mounting on the posts of the curtain wall system in the walls 16 and 15 respectively. Thus the panels 126 and 127 include side panel portions 128 and a top panel portion 129 which surround the door and form the panel into a predetermined dimension matching the width between the posts and matching a required spaced between the floor and a mullion bar. The remaining spaces between the posts can be formed by transparent panels 31 as previously described or by insulated non transparent filler panels 130.

In FIG. 8 is shown one possible location of the water pump system 131 for supplying water under pressure of the order of 1000 PSI for supplying the water nozzles for the humidification system. Additional water nozzles (not shown) can also be provided in the area underneath the horizontal discharge ducts 54 for increased humidification levels and/or in the area of the roof vents so as to provide water evaporative cooling of the air. The control system 110 previously described controls the supply of water from the pump system 131 to the individual nozzles so as to provide the required effect either within the fan housing or within the other areas of the greenhouse as is required and is known to persons skilled in the art.

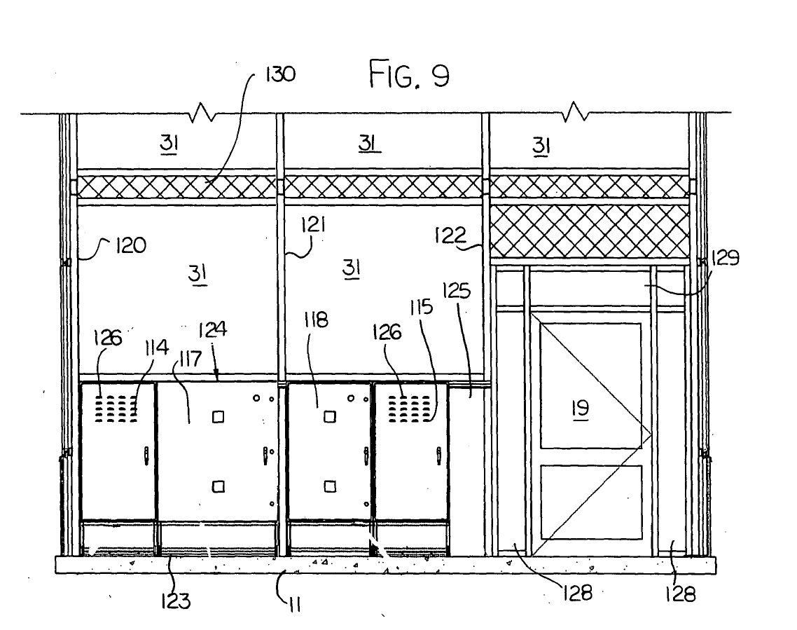

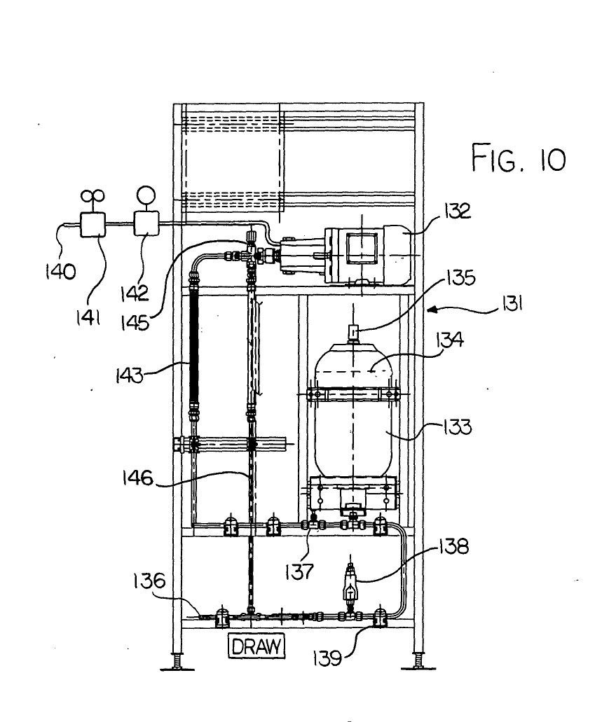

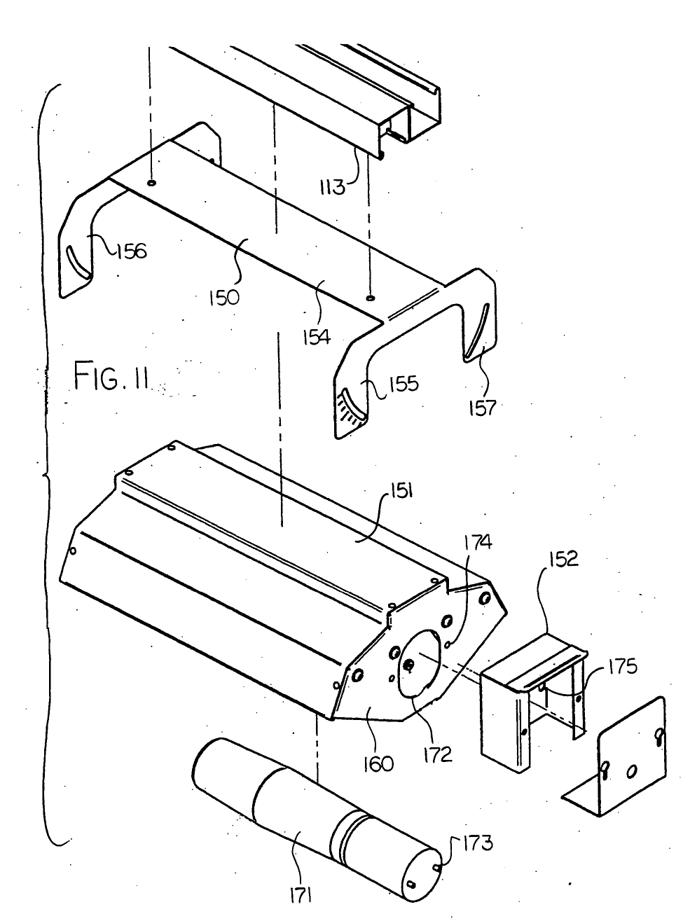

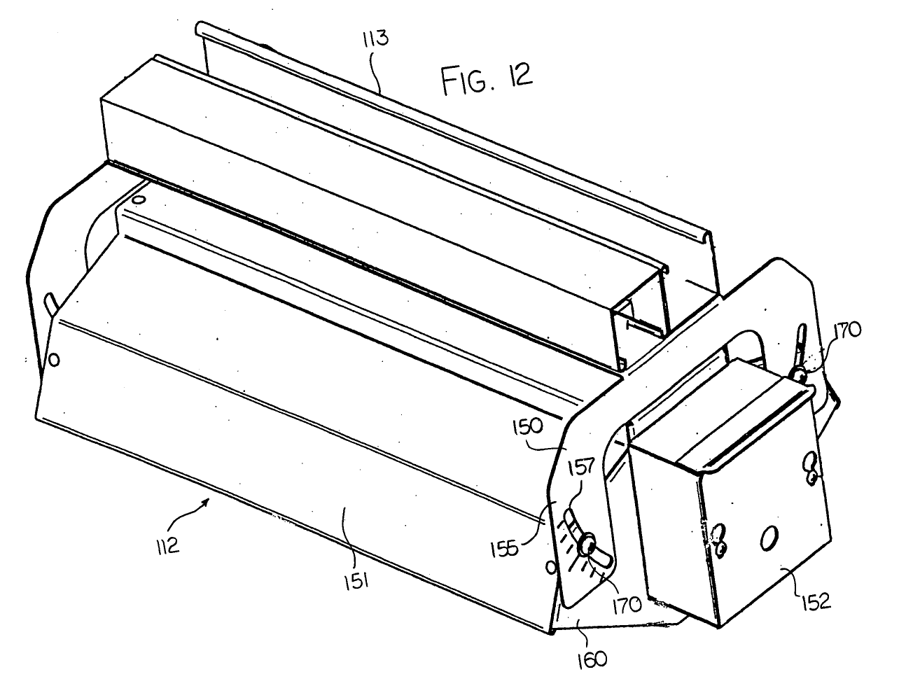

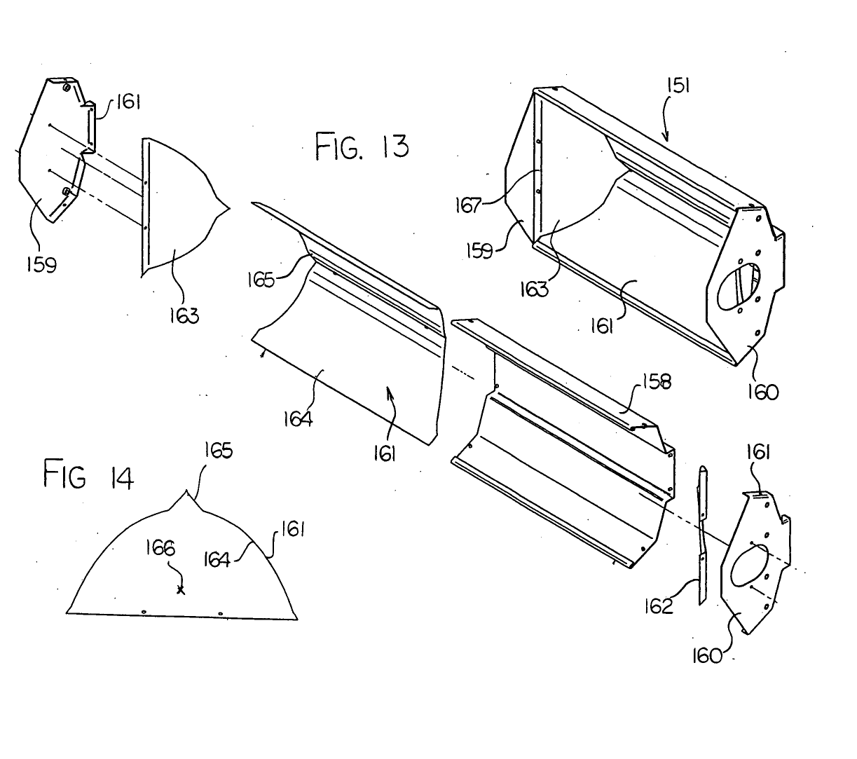

Turning now to FIG. 10, the pump system 131 is shown in more detail which comprises a pump 132 and an accumulator 133. The accumulator 133 includes a bladder 134 with nitrogen contained within the bladder injected from a pressure nozzle 135. The accumulator tank 133 is designed to receive and contain the water under the high pressure of the order of 1000 PSI for supplying the injection nozzles. The outlet to the nozzles is indicated at 136. Water supplied to the pump 132 at an inlet line 140 is controlled by a valve 141 and a pressure sensor 142 and is pumped to the pressure of the order of 1000 PSI which is pumped into the accumulator through a line 143 controlled by valves 137 until the pressure within the accumulator as detected by a pressure valve 138 reaches the required maximum operating pressure at which time the pump is shut off. Water under pressure is then supplied from the accumulator under the control of the valve arrangements 139 to the nozzles as required. The outlet pressure is maintained above a predetermined minimum as detected by a pressure detector 138 and when the minimum is reached the pump is reactivated to pump more water into the accumulator. An over pressure valve 145 can detect running of the pump beyond a required pressure and switches the output of the pump to a drain line 146.

One of the lighting fixtures 112 on the rail 113 is shown in more detail. This comprises a mounting bracket 150, a reflector housing 151 and a bulb support 152. The mounting bracket 150 comprises a base plate 154 and two side plates 155 and 156 arranged at right angles to the base plate. Each mounting plate 155, 156 is generally U shaped with two depending legs each at a respective side of the base plate 150. Each depending leg has a mounting slot 157 which is arcuate around a pivot axis extending approximately centrally along the plane of the base plate 150.

The reflector housing 151 comprises a backing member 158 which is generally channel shaped and two end plates 159 and 160 which are arranged at right angles to the backing plate. The end plates 159 and 160 include flanges 161 along the side edges thereof and are shaped to match the channel pattern of the backing plate so that the flanges engage onto the surfaces of the backing plate and can be fastened thereto by screws to form a channel shape member closed at both ends and with an open face for receiving the reflectors 161, 162 and 163.

The main reflector 161 is generally channel shaped and has a main parabolic surface 164. At the center of the parabolic surface is provided a V-shaped recess 165. The V-shaped recess extends along the length of the channel shaped reflector and has an angle at the base of the order of 90°. The V-shaped recess is located directly above the axis 166 of the parabolic shape of the reflector. The provision of the V-shaped recess prevents light from a bulb located approximately at the axis 166 from being reflected directly back to the center of the bulb which tends to cause excess heating of the bulb. Thus the V-shaped recess reflects light extending from the axis vertically upwardly into the recess away from the bulb and toward another surface of the reflector so that the light from the bulb is reflected downwardly by the reflector but away from the center of the bulb.

The reflector elements 162 and 163 are inclined from the plates 160 and 159 respectively. Each of the reflector elements attaches to the end plate and is inclined inwardly so that its spacing at the V-shaped recess 165 is less than its spacing at the end plate. The elements 162 and 163 are generally planar and have an inside surface which is shaped to match the base of the main reflector 161, bearing in mind the angle of the reflector element to the main reflector which changes the shape of the parabolic surface and the angle of the V-shaped portion to match those elements on the main reflector.

The outside edge of the reflector elements 162 and 163 forms a straight line at a flange 167 which is attached at the edges of the main reflector element 161. Thus the bottom edge of the reflector defined by the reflector elements and the main reflector body lies in a plane just below the axis of the parabola. The end plates 159 and 160 include an extra projecting piece beyond the flange 167 which provides a mounting portion for receiving the bulb mounting bracket 152. The flange 167 lies in the plane of the end plate which is of course at an angle to the plane of the main part of the reflector element to which it is attached.

The mounting plates 159 and 160 are arranged to lie as a sliding fit just inside the plates 155 and 156 of the mounting bracket 150. The mounting plate 160 is thus fastened to the plate 155 by screws 170 passing through the slots 157. Thus the angle of the mounting bracket 150 relative to the plane joining the base of the V-shaped groove to the axis of the reflector can be changed so as to change the direction of light reflected from the bulb by the reflector. The intermediate rows of the lights of the construction as shown in FIG. 1 are arranged so that they are directed vertically downwardly thus forming a spread pattern of the light from the reflector which is arranged to be maximized at a height of the order of five feet from the top of the growing plants. The reflector housings of the lights in the end rows at the side walls 12 and 13 are turned so that the angle is adjusted so that the light is reflected downwardly and inwardly into the greenhouse so as to increase the amount of light reflected into the greenhouse.

A bulb and associated socket 171 is mounted in the bulb mounting bracket and junction box 152 so that the socket is carried in the junction box with the bulb projecting through a hole 172 in the end plate 160. Connector pins 173 of the socket connect into suitable connecting elements within the junction box and bracket 152 of a conventional nature. The mounting bracket 152 carrying the bulb and socket can move upwardly and downwardly on the end plate 160 by screws which engage through holes 174 in the end plate 160 and pass through slots 175 in the mounting bracket. Thus the height of the bulb is adjusted upwardly and downwardly relative to the axis of the parabola. In order to allow such upward and downward adjustment, the hole 172 is slightly elongate so that its height is greater than its width which matches generally the neck of the bulb.

The rails 113 extend substantially along the full length of the benches and are aligned with the posts at the end of the greenhouse in the wall 14 and thus are aligned with the roof rafters. A lifting system of a conventional nature including pulleys and winches can raise and lower the whole array of rows of lighting fixtures as a whole so as to maintain the spacing of the base of the reflectors from the top of the plants to the optimum distance determined by the shape of the reflector which is arranged to be five feet.

Since various modifications can be made in my invention as herein above described, and many apparently widely different embodiments of same made within the spirit and scope of the claims without departing from such spirit and scope, it is intended that all matter contained in the accompanying specification shall be interpreted as illustrative only and not in a limiting sense.

1. A greenhouse comprising:
an exterior wall structure having an end wall and two side walls at right angles to the end wall, each of which includes primarily transparent panels allowing entry to an interior of natural light;
a plurality of elongate parallel benches located side by side within the interior at right angles to the end wall and arranged to provide generally horizontal support surfaces for supporting plant materials thereon for receiving the natural light and growing within the interior;
and a lighting system for supplying artificial light to the plant materials on the support surfaces comprising a plurality of rails arranged in parallel spaced positions in a common horizontal plane at a height above the benches with the rails extending parallel to the benches;
each rail supporting a plurality of the lighting fixtures in a row along the rail;
each lighting fixture comprising:
a mounting member for attachment to the respective rail;
a generally parabolic reflector carried on the mounting member so as to be depended facing generally downwardly toward the plant material for directing light toward the plant material;
a lighting bulb support for receiving and supporting a bulb at a position within the parabolic reflector such that light therefrom is reflected by the reflector;
wherein the mounting member of each lighting fixture is pivotal about an axis generally parallel to a parabolic axis of the parabolic reflector relative to the parabolic reflector and to the bulb support so as to adjust the angle of the directed light relative to the rail;
and wherein that row of lighting fixtures adjacent each side wall has the lighting fixtures adjusted such that the lighting direction is angled downwardly and inwardly of the respective side wall.

2. The greenhouse according to claim 1 wherein the bulb support is movable relative to the parabolic reflector so as to move the bulb within the axial plane of the parabolic reflector so as to move the bulb relative to the parabolic axis.

3. The greenhouse according to claim 2 wherein the parabolic reflector has end walls at right angles to the plane and the bulb support is movable along end walls.

4. The greenhouse according to claim 1 wherein the parabolic reflector has a generally parabolic shape with a recessed notch in the reflector at the axial plane.

5. The greenhouse according to claim 1 wherein the recessed notch is V-shaped.

6. The greenhouse according to claim 1 wherein the parabolic reflector has end walls at right angles to the plane and has inclined ends panels extending from the end walls inwardly and upwardly toward the top of the parabolic shape.

7. The greenhouse according to claim 1 wherein the end wall has a plurality of posts at spaced positions along the end wall and there are provided beams mounted on the posts and extending parallel to the side walls between the side walls and wherein the rails include a plurality of inner rails aligned with posts and beams and two outer rails each adjacent a respective one of the side walls.

8. The greenhouse according to claim 7 wherein the rails are interconnected to form an array and are suspended from the beams for common height adjustment of the array.

9. The greenhouse according to claim 8 wherein the rail height is adjustable to provide an adjustable spacing from top of crop material so that the height can be adjusted to provide a predetermined spacing from the crop as the crop material grows and wherein the reflectors of the array are designed to maximize light intensity at the predetermined spacing.

10. The greenhouse according to claim 9 wherein the predetermined spacing is of the order of 5 feet.

11. The greenhouse according to claim 1 wherein each light fixture is associated with a ballast and wherein the ballasts of all the lighting fixtures of the array are associated together in at least one electrical cabinet mounted separately of the lighting fixtures.

12. The greenhouse according to claim 11 wherein the exterior wall structure is formed from a plurality of posts and wall panels spanning the posts and wherein the at least one cabinet is mounted in wall panel.

13. A greenhouse comprising:
an exterior wall structure having an end wall and two side walls at right angles to the end wall, each of which includes primarily transparent panels allowing entry to an interior of natural light;
a plurality of elongate parallel benches located side by side within the interior at right angles to the end wall and arranged to provide generally horizontal support surfaces for supporting plant materials thereon for receiving the natural light and growing within the interior;
and a lighting system for supplying artificial light to the plant materials on the support surfaces comprising a plurality of rails arranged in parallel spaced positions in a common horizontal plane at a height above the benches with the rails extending parallel to the benches;
each rail supporting a plurality of the lighting fixtures in a row along the rail;
each lighting fixture comprising:
a mounting member for attachment to the respective rail;
a generally parabolic reflector carried on the mounting member so as to be depended facing generally downwardly toward the plant material for directing light toward the plant material;
a lighting bulb support for receiving and supporting a bulb at a position within the parabolic reflector such that light therefrom is reflected by the reflector;
wherein the bulb support is movable relative to the parabolic reflector so as to move the bulb within the axial plane of the parabolic reflector so as to move the bulb relative to the parabolic axis to accommodate different types of bulb.

14. A greenhouse comprising:
an exterior wall structure having an end wall and two side walls at right angles to the end wall, each of which includes primarily transparent panels allowing entry to an interior of natural light;
a plurality of elongate parallel benches located side by side within the interior at right angles to the end wall and arranged to provide generally horizontal support surfaces for supporting plant materials thereon for receiving the natural light and growing within the interior;
and a lighting system for supplying artificial light to the plant materials on the support surfaces comprising a plurality of rails arranged in parallel spaced positions in a common horizontal plane at a height above the benches with the rails extending parallel to the benches;
each rail supporting a plurality of the lighting fixtures in a row along the rail;
each lighting fixture comprising:
a mounting member for attachment to the respective rail;
a generally parabolic reflector carried on the mounting member so as to be depended facing generally downwardly toward the plant material for directing light toward the plant material;
a lighting bulb support for receiving and supporting a bulb at a position within the parabolic reflector such that light therefrom is reflected by the reflector;
wherein the end wall has a plurality of posts at spaced positions along the end wall and there are provided beams mounted on the posts and extending parallel to the side walls between the side walls and wherein the rails include a plurality of inner rails aligned with posts and beams and two outer rails each adjacent a respective one of the side walls;
and wherein the rails are interconnected to form an array and are suspended from the beams for common height adjustment of the array.

15. The greenhouse according to claim 14 wherein the rail height is adjustable to provide an adjustable spacing from top of crop material so that the height can be adjusted to provide a predetermined spacing from the crop as the crop material grows and wherein the reflectors of the array are designed to maximize light intensity at the predetermined spacing.

16. The greenhouse according to claim 15 wherein the predetermined spacing is of the order of 5 feet.

17. A greenhouse comprising:
an exterior wall structure having an end wall and two side walls at right angles to the end wall, each of which includes primarily transparent panels allowing entry to an interior of natural light;
a plurality of elongate parallel benches located side by side within the interior at right angles to the end wall and arranged to provide generally horizontal support surfaces for supporting plant materials thereon for receiving the natural light and growing within the interior;
and a lighting system for supplying artificial light to the plant materials on the support surfaces comprising a plurality of rails arranged in parallel spaced positions in a common horizontal plane at a height above the benches with the rails extending parallel to the benches;
each rail supporting a plurality of the lighting fixtures in a row along the rail;
each lighting fixture comprising:
a mounting member for attachment to the respective rail;
a generally parabolic reflector carried on the mounting member so as to be depended facing generally downwardly toward the plant material for directing light toward the plant material;
a lighting bulb support for receiving and supporting a bulb at a position within the parabolic reflector such that light therefrom is reflected by the reflector;
wherein the parabolic reflector has a generally parabolic shape with a recessed notch in the reflector at the axial plane.

18. The greenhouse according to claim 17 wherein the recessed notch is V-shaped.

19. The greenhouse according to claim 17 wherein the parabolic reflector has end walls at right angles to the plane and has inclined ends panels extending from the end walls inwardly and upwardly toward the top of the parabolic shape.

20. The greenhouse according to claim 17 wherein the bulb support is movable relative to the parabolic reflector so as to move the bulb within the axial plane of the parabolic reflector so as to move the bulb relative to the parabolic axis to accommodate different types of bulb.

21. The greenhouse according to claim 20 wherein the parabolic reflector has end walls at right angles to the plane and the bulb support is movable along end walls.

22. A greenhouse comprising:
an exterior wall structure having an end wall and two side walls at right angles to the end wall, each of which includes primarily transparent panels allowing entry to an interior of natural light;
a plurality of elongate parallel benches located side by side within the interior at right angles to the end wall and arranged to provide generally horizontal support surfaces for supporting plant materials thereon for receiving the natural light and growing within the interior;
and a lighting system for supplying artificial light to the plant materials on the support surfaces comprising a plurality of rails arranged in parallel spaced positions in a common horizontal plane at a height above the benches with the rails extending parallel to the benches;
each rail supporting a plurality of the lighting fixtures in a row along the rail;
each lighting fixture comprising:
a mounting member for attachment to the respective rail;
a generally parabolic reflector carried on the mounting member so as to be depended facing generally downwardly toward the plant material for directing light toward the plant material;
a lighting bulb support for receiving and supporting a bulb at a position within the parabolic reflector such that light therefrom is reflected by the reflector;
wherein each light fixture is associated with a ballast and wherein the ballasts of all the lighting fixtures of the array are associated together in at least one electrical cabinet mounted separately of the lighting fixtures.

23. The greenhouse according to claim 22 wherein the exterior wall structure is formed from a plurality of posts and wall panels spanning the posts and wherein the at least one cabinet is mounted in wall panel.
